(19) United States
(12) Patent Application Publication
(10) Pub. No.: US 2005/0262963 A1
(43) Pub. Date: Dec. 1, 2005

(54) Divided connecting rod having a screwed connecting rod cover

(75) Inventors: Jochen Betsch, Waiblingen (DE); Michael Dettenmaier, Winnenden (DE); Dirk Heinrich, Stuttgart (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/138,164

(22) Filed: May 26, 2005

(30) Foreign Application Priority Data
May 27, 2004 (DE) DE102004025934.8

(51) Int. Cl. G05G 1/00

(52) U.S. Cl. 74/579 R

(57) ABSTRACT

A connecting rod is designed to be divided at the large connecting rod eye and the connecting rod cover is connected by screw means to a connecting rod. In a threadless area of the screw means, securing means are provided between the screw means and a part of the connecting rod. The installed screw means may be braced by the securing means with respect to a part of the connecting rod.

Priority is claimed to German Patent Application No. DE 10 2004 025 934.8, filed on May 27, 2004, the entire disclosure of which is incorporated by reference herein.

The present invention relates generally to a connecting rod, and more particularly to a divided connecting rod.

### BACKGROUND

In the area of the large connecting rod eye, divided connecting rods are known in the general related art. During assembly on the crankshaft, connecting rod covers of the divided connecting rods are typically connected to the remaining connecting rod by screw connections. DE 41 43 320 C2 may be mentioned here as an example. However, screw connections designed as high-strength screw connections are exposed to very high dynamic loads. The screw connections are usually not actually secure, despite a mathematical certainty of not loosening. Therefore, the screw connection may become loosened, which may in turn result in splitting of the connecting rod with corresponding damage to the internal combustion engine.

Conventional locking devices to prevent loss and loosening of screws are out of the question here because of the highly dynamic loads on the screw connections. Experience has shown that even gluing the screw and thread and/or using screws coated with screw lock adhesive in the area of the thread does not entirely prevent screws from loosening in the connection of the connecting rod cover and connecting rod.

KR 2003031680 A describes a screw for a divided connecting rod having an asymmetrical screw head. This ensures asymmetrical force distribution in the screw, although only if the screw is in the proper end position after being screwed in, in order to reduce the risk of opening, i.e., separation of connecting rod cover and connecting rod and thus ultimately also the risk of detachment of the screw connection.

This configuration is sensitive with regard to the end position of the screw and may become loosened under dynamic loads.

DE 33 41 364 A1 also describes a conical thread for the screw connection of a connecting rod cover; the thread should counteract loosening of the threaded bolt. However, this yields the disadvantage that it is difficult to implement a predetermined contact force between the bearing faces through a predetermined tightening torque via the conical thread. Plastic deformation of the thread may also occur.

### SUMMARY OF THE INVENTION

An object of the present invention is to provide a divided connecting rod which will reliably secure holding of its screw connections under conventional operating circumstances.

The present invention provides a connecting rod which is designed to be divided at the large connecting rod eye, a connecting rod cover being connected to a connecting rod by screw means, wherein securing means are provided in an area of the screw means having no thread between the screw means and a part of the connecting rod, thereby bracing the installed screw means with respect to a part of the connecting rod.

Clamping the screw means with respect to a part of the connecting rod via the securing means permanently increases the torque required to loosen the screw means. Thus an automatic loosening of the screw connection of the connecting rod which is under highly dynamic stress in the area of the divided connecting rod eye may be prevented.

### BRIEF DESCRIPTION OF THE DRAWINGS

Refinements and advantageous embodiments of the present invention are derived from the claims and from the exemplary embodiments which are explained in greater detail below with reference to the drawings, in which:

FIG. 1 shows a part of a connecting rod having a divided connecting rod eye;

FIG. 2 shows an enlargement of area II-IV from FIG. 1 in a first embodiment of the present invention;

FIG. 3 shows an enlargement of area II-IV from FIG. 1 in a second embodiment of the present invention;

FIG. 4 shows an enlargement of area II-IV from FIG. 1 in a third embodiment of the present invention;

FIG. 5 shows a schematic diagram of possible securing means.

### DETAILED DESCRIPTION

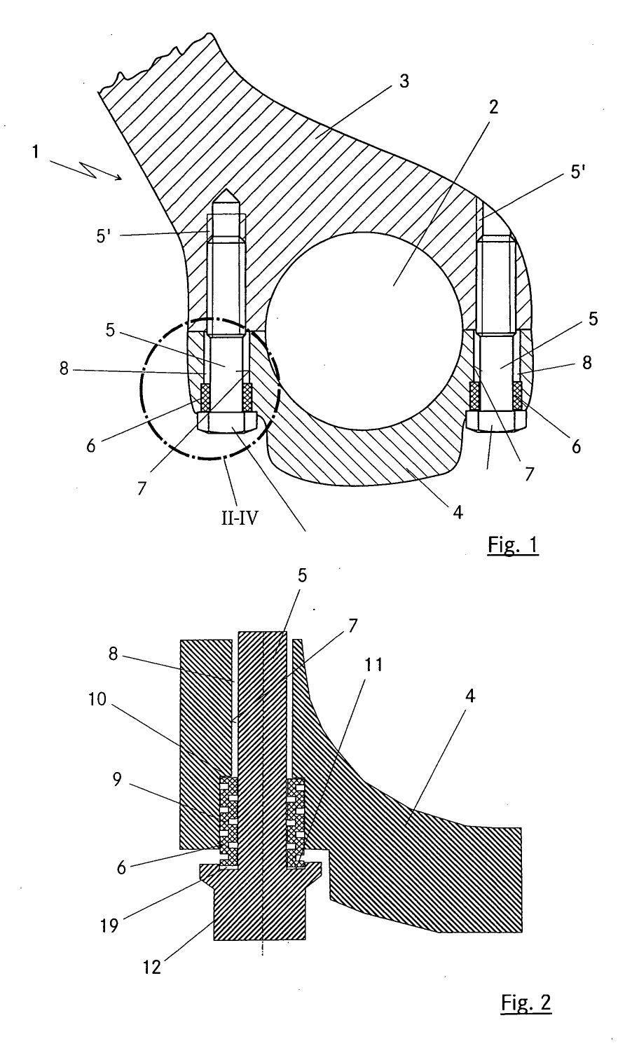

FIG. 1 shows a part of a connecting rod 1. This part includes a large connecting rod eye 2 which accommodates a crankshaft (not shown) when connecting rod 1 is used in an internal combustion engine. In the area of this connecting rod eye 2, connecting rod 1 is divided into two bearing shells, one in actual connecting rod (rod portion) 3 and one in connecting rod cover 4. To mount connecting rod 1 on the crankshaft, connecting rod cover 4 is connected to connecting rod portion 3 by suitable screw means 5 and connecting rod eye 2 is thus closed around the crankshaft.

The screw connection is a critical location because screw means 5 which are under high dynamic stresses repeatedly become loosened despite hypothetical mathematical certainty of not becoming loosened and thus allow connecting rod cover 4 to separate from connecting rod portion 3.

To prevent such loosening of screw means 5, various types of securing means 6 are depicted below in the enlargements of area II-IV. All types of securing means 6 cause an elastic and/or plastic deformation of securing means 6 during assembly of screw means 5. Therefore, installed screw means 5 are braced with respect to connecting rod 1. In particular, securing means 6 radially brace mounted screw means 5 with respect to a wall 7 of a borehole 8 for screw means 5, in the present case borehole 8 through connecting rod cover 4, via a radial expansion due to their axial deformation.

The example in FIG. 1 shows one-piece screws 5 that are screwed into a thread 5′ provided in connecting rod portion 3. However, other types of screw connections are also conceivable within the scope of the present invention. The one-piece screws 5 shown in FIG. 1 are particularly favorable. Because they are in one piece, they may be secured in a single area by securing means 6. The area of boreholes 8 situated in connecting rod cover 4 on the side facing away from connecting rod portion 3 is particularly suitable because of its good accessibility for the installation of screws 5.

To ensure tight and secure seating of screws 5 in their thread 5′, securing means 6 are provided in an area of screws 5 which does not have any thread. However, due to the bracing of screws 5 with respect to connecting rod cover 4, an increased torque required for loosening screws 5 is ensured even without having to influence the area of thread 5′.

FIG. 2 shows a first embodiment of securing means 6 in the manner of a grooved sleeve 9 before assembly of screw 5. Grooved sleeve 9 may be made of spring steel, e.g., according to DIN 17221, DIN 17222, DIN 17223 or DIN 17224 or a soft metal such as copper alloys, aluminum alloys, brass, etc. Grooved sleeve 9 is situated in an area 10 of borehole 8 which has a slightly larger diameter to accommodate this grooved sleeve 9. Grooved sleeve 9 is axially compressed in subsequent assembly of screw 5 through a face 11 of a screw head 12 of screw 5 facing it, between screw head 12 and the transition from area 10 of borehole 8 having the larger diameter with respect to the remaining course of borehole 8 (not shown). Due to this axial compression, elastic or elastic and plastic deformation occurs in grooved sleeve 9 in a radial direction, depending on the force action, the material and the selected geometry of grooved sleeve 9. Grooved sleeve 9, which undergoes deformation in this way during assembly, thus applies tension to screw 5 with respect to wall 7 of borehole 8 in connecting rod cover 4. This bracing of screw 5 with respect to connecting rod cover 4 by securing means 6 significantly increases the torque required to loosen screws 5. Security with respect to loosening of the screw connection of connecting rod cover 4 may thus be increased substantially.

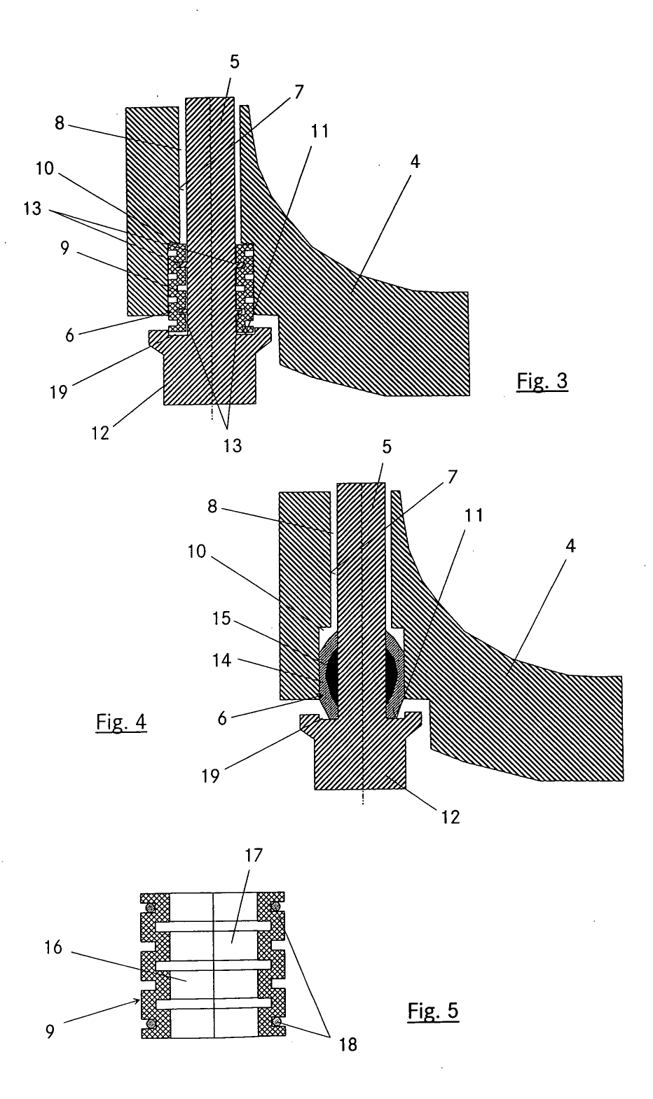

FIG. 3 shows another embodiment of securing means 6 in which grooved sleeve 9 is used in combination with suitable protrusions 13; alternatively, guide grooves would also be conceivable in the area of screw 5. Due to these protrusions 13 corresponding to grooved sleeve 9, an increased contact surface and thus increased friction between screw 5 and securing means 6 are achieved. The deformation of grooved sleeve 9 and the resulting tension between screw 5 and connecting rod cover 4 may thus be further improved.

Another embodiment of securing means 6 is shown in FIG. 4 where securing means 6 are also implemented by a sleeve 14, the space remaining between sleeve 14 and screw 5 being filled with a polymer material 15. In addition to axial deformation and the resulting radial tension, similar to the above example, polymer material 15 offers the special advantage that molecules are incorporated, accompanied by an increase in volume, during the intended use of connecting rod 1. Polymer material 15 practically “swells” and thus increases the force of the radial tension, resulting in securing means 6 being able to secure screw 5 even better against loosening. In particular such crosslinked polymers capable of incorporating molecules under the atmosphere usually prevailing in an internal combustion engine are suitable as polymer material 15. Such polymer materials 15 might include, for example, polyamides having a high water uptake propensity, natural rubber which swells in mineral oil, styrene-butadiene rubber which incorporates mineral oil, fat and fuels while increasing in volume, and silicone rubber or the like which swells on contact with fuels and water vapor.

Sleeve 14 surrounding polymer material 15 and protecting it during assembly may be designed like grooved sleeve 9, e.g., made of spring steel or a soft metal. Due to the deformation of sleeve 14 during installation, parts of polymer material 15 become accessible to the ambient atmosphere, so that the aforementioned incorporation of molecules may take place during operation of the internal combustion engine equipped with connecting rod 1.

Another advantage of polymer material 15, which has mainly elastic properties, is that it results in an increase in damping in the screw-connecting rod vibrating system. This also has a positive effect on the security of the screw connections.

In the case of both types of securing means 6, sleeves 9, 14 and/or sleeve 14 filled with polymer material 15 is/are designed to be divided into two halves 16, 17 in a particularly favorable manner, as indicated in the example of grooved sleeve 9 in FIG. 5. In principle, a division into three or four individual subareas would also be conceivable here. Halves 16, 17 may then be placed around the threadless area of screw 5. Since sleeve 9, 14 need not be pushed over the thread of screw 5 having a slightly larger diameter, sleeve 9, 14 may be designed to fit the threadless area of screw 5 exactly. Together with a diameter of area 10 which is only slightly larger than the outside diameter of particular sleeve 9, 14, this yields a very large frictional contact surface with even very slight radial deformation of sleeve 9, 14 and thus there is very good bracing of screw 5 against connecting rod cover 4.

Typically two halves 16, 17 of sleeve 9, 14 may be glued to facilitate assembly, e.g., glued to the threadless area of screw 5. Alternatively, for example, it is also conceivable for halves 16, 17 of sleeve 9, 14 to be connected in the manner indicated in FIG. 5 (not including screw 5 here) via one or more locking rings 18 which may be designed as snap rings, for example (e.g., according to DIN 9045).

To prevent lateral yielding of sleeve 9, 14, screw head 12 may have a groove 19 partially accommodating sleeve 9, 14. Furthermore, face 11 of screw head 12 facing sleeve 9, 14 may have a profile to establish a form-fitting connection with sleeve 9, 14, which assumes a corresponding negative shape in at least partial areas due to the deformation. The profile may be in particular in the manner of a sawtooth profile counteracting loosening of screw 5.

1. A connecting rod comprising:
a rod portion;
a connecting rod eye;
a connecting rod cover;
a screw element connecting the connecting rod cover to the rod portion at a region of the connecting rod eye;
a securing element disposed in an area between the screw element and one of the rod portion and the connecting rod cover, the area having no thread, the securing element bracing the screw element with respect to the one of the rod portion and the connecting rod cover.

2. The connecting rod as recited in claim 1, further comprising a borehole receiving the screw element, and wherein the securing element is disposed in the borehole so as to radially brace the installed screw element with respect to a wall of the borehole.

3. The connecting rod as recited in claim 1, wherein the securing element includes a grooved sleeve.

4. The connecting rod as recited in claim 3, wherein grooved sleeve includes at least one groove and wherein the screw element has one of protrusions and guide grooves corresponding to the at least one groove.

5. The connecting rod as recited in claim 1, wherein the securing element includes a polymer material surrounded at least partially by a sleeve.

6. The connecting rod as recited in claim 5, wherein the polymer material is configured to incorporate molecules and increase in volume during the intended use of the connecting rod.

7. The connecting rod as recited in claim 6, wherein the polymer material is configured to incorporate oil-based substances.

8. The connecting rod as recited in claim 6, wherein the polymer material is configured to incorporate water.

9. The connecting rod as recited in claim 3, wherein the sleeve is divided into at least two partial shells.

10. The connecting rod as recited in claim 9, wherein each of the at least two partial shells are adhesively joined to the screw element.

11. The connecting rod as recited in claim 9, wherein the sleeve includes at least one locking ring disposed around the screw element and connected to the at least two partial shells.

12. The connecting rod as recited in claims 3, wherein the sleeve is made of spring steel.

13. The connecting rod as recited in claim 3, wherein the sleeve is made of a soft metal.

14. The connecting rod as recited in claim 2, wherein a first diameter of the borehole in the area of the securing element is larger than a second diameter of the remaining portion of the borehole.

15. The connecting rod as recited in claim 1, wherein the screw element includes a one-piece screw.

16. The connecting rod as recited in claim 15, wherein the securing element is disposed on a side of the screw facing a head of the screw.

17. The connecting rod as recited in claim 16, wherein an area of the screw head facing the securing element includes a groove corresponding to a diameter of the securing element.

18. The connecting rod as recited in claim 16, wherein the area of the screw head facing the securing element has a profiled surface.

19. The connecting rod as recited in claim 18, wherein the profiled surface includes a sawtooth profile.
